(19) United States
(12) Patent Application Publication
(10) Pub. No.: US 2011/0176725 A1
(43) Pub. Date: Jul. 21, 2011

(54) LEARNING APPARATUS, LEARNING METHOD AND PROGRAM

(75) Inventors: Shunichi HOMMA, Tokyo (JP); Yoshiaki Iwai, Tokyo (JP); Takayuki Yoshigahara, Tokyo (JP)

(73) Assignee: Sony Corporation, Tokyo (JP)

(21) Appl. No.: 12/951,448

(22) Filed: Nov. 22, 2010

(30) Foreign Application Priority Data
Jan. 21, 2010 (JP) 2010-011356

(51) Int. Cl. G06K 9/62

(52) U.S. Cl. 382/159

(57) ABSTRACT

A learning apparatus includes a learning section which learns, according as a learning image used for learning a discriminator for discriminating whether a predetermined discrimination target is present in an image is designated from a plurality of sample images by a user, the discriminator using a random feature amount including a dimension feature amount randomly selected from a plurality of dimension feature amounts included in an image feature amount indicating features of the learning image.

### BACKGROUND OF THE INVENTION

1. Field of the Invention

The present invention relates to a learning apparatus, a learning method and a program, and more particularly, to a learning apparatus, a learning method and a program which are suitable to be used, for example, in a case of learning a discriminator for discriminating whether a predetermined discrimination target is present in an image on the basis of a small number of learning images.

2. Description of the Related Art

In the related art, there has been proposed an image classification method for classifying a plurality of images into classes corresponding to subjects thereof and for generating an image cluster including the classified images for each class.

For example, in this image classification method, it is discriminated whether a predetermined discrimination target is present in each of the plurality of images, using a discriminator for discriminating whether a predetermined discrimination target (for example, a human face) is present in an image.

Further, the plurality of images is respectively classified into either of a class in which the predetermined discrimination target is present in an image or a class in which the predetermined discrimination target is not present in the image on the basis of the discrimination result, and then an image cluster is generated for each classified class.

Here, in a case where a discriminator is generated (learned) for use in the image classification method in the related art, it necessitates a large amount of learning images to which a correct solution label indicating whether the predetermined discrimination target is present in the image is attached and huge operations for generating the discriminator on the basis of the large amount of learning images.

Thus, while it is relatively easy for enterprises and research institutions to prepare a computer capable of processing the large amount of learning images and carrying out huge operations necessary for generating the above-described discriminator, but it is very difficult for individuals to prepare it.

For this reason, it is very difficult for individuals to generate a discriminator used for generating desired image cluster for each individual.

Further, there has been proposed a search method for searching an image in which a predetermined discrimination target is present in an image, among a plurality of images, using a discriminator for discriminating a predetermined discrimination target which is present in an image (refer to Japanese Unexamined Patent Application Publication No. 2008-276775, for example).

In this search method, a user designates positive images in which the predetermined discrimination target is present in the image and negative images in which the predetermined discrimination target is not present in the image, among the plurality of images. Further, a discriminator is generated using the positive images and the negative images designated by the user, as learning images.

Further, in this search method, the images in which the predetermined discrimination target is present in the image are searched from the plurality of images, using the generated discriminator.

In this search method, the discriminator is rapidly generated by rapidly narrowing a solution space, and thus a desired image can be more rapidly searched.

Here, in order to generate a discriminator with high accuracy for discriminating a predetermined discrimination target, a large number of various positive images (for example, positive images in which the predetermined discrimination target is photographed at a variety of angles) should be provided.

However, in the above-described search method, since the user designates the learning images sheet by sheet, the number of the learning images is very small compared the number of the learning images used for generating the discriminator in the image classification method in the related art. As a result, the number of the positive images is also very small among the learning images.

Learning of the discriminator using the positive images which are very small in number easily causes over-learning (over-fitting), thereby lowering the discrimination accuracy of the discriminator.

Further, although the number of the learning images is small, in a case where an image feature amount indicating features of a learning image is expressed as a vector with several hundreds to several thousands of dimensions through bag-of-words, combinations of the plurality of features in the learning image, or the like, and where the discriminator is generated using the vector as the learning image, as could be expected, over-learning easily occurs due to the high-dimensional vector.

In addition, there has been proposed a method, in a case where a discriminator is generated, using bagging so as to enhance generalization performance of the discriminator (refer to Leo Breiman, Bagging Predictors, Machine Learning, 1996, 123-140, for example).

However, even in this method using bagging, although the number of learning images is small, in a case where an image feature amount of a learning image expressed as a vector with several hundreds to several thousands of dimensions is used, as could be expected, the over-learning occurs.

### SUMMARY OF THE INVENTION

As described above, in a case where a discriminator is generated using a small number of learning images, when an image feature amount expressed as a vector with several hundreds to several thousands of dimensions is used as an image feature amount of a learning image, over-learning occurs, thereby making it difficult to generate a discriminator having high discrimination accuracy.

Accordingly, it is desirable to provide a technique which can suppress over-learning to thereby learn a discriminator having high discrimination accuracy, in learning using a relatively small number of learning images.

According to an embodiment of the present invention, there are provided a learning apparatus including learning means for learning, according as a learning image used for learning a discriminator for discriminating whether a predetermined discrimination target is present in an image is designated from among a plurality of sample images by a user, the discriminator using a random feature amount including a dimension feature amount randomly selected from a plurality of dimension feature amounts included in an image feature amount indicating features of the learning image, and a program which enables a computer to function as the learning means.

The learning means may learn the discriminator through margin maximization learning for maximizing a margin indicating a distance between a separating hyper-plane for discriminating whether the predetermined discrimination target is present in the image and a dimension feature amount existing in proximity to the separating hyper-plane among dimension feature amounts included in the random feature amount, in a feature space in which the random feature amount is present.

The learning means may include: image feature amount extracting means for extracting the image feature amount which indicates the features of the learning image and is expressed as a vector with a plurality of dimensions, from the learning image; random feature amount generating means for randomly selecting some of the plurality of dimension feature amounts which are elements of respective dimensions of the image feature amount and for generating the random feature amount including the selected dimension feature amounts; and discriminator generating means for generating the discriminator through the margin maximization learning using the random feature amount.

The discriminator may output a final determination result on the basis of a determination result of a plurality of weak discriminators for determining whether the predetermined discrimination target is present in a discrimination target image, the random feature amount generating means may generate the random feature amount used to generate the weak discriminators for each of the plurality of weak discriminators, and the discriminator generating means may generate the plurality of weak discriminators on the basis of the random feature amount generated for each of the plurality of weak discriminators.

The discriminator generating means may further generate confidence indicating the level of reliability of the determination of the weak discriminators, on the basis of the random feature amount.

The discriminator generating means may generate the discriminator which outputs a discrimination determination value indicating a product-sum operation result between a determination value which is a determination result output from each of the plurality of weak discriminators and the confidence, on the basis of the plurality of weak discriminators and the confidence, and the discriminating means may discriminate whether the predetermined discrimination target is present in the discrimination target image, on the basis of the discrimination determination value output from the discriminator.

The random feature amount generating means may generate a different random feature amount whenever the learning image is designated by the user.

The learning image may include a positive image in which the predetermined discrimination target is present in the image and a negative image in which the predetermined discrimination target is not present in the image, and the learning means may further include negative image adding means for adding a pseudo negative image as the learning image.

The learning means may further include positive image adding means for adding a pseudo positive image as the learning image in a case where a predetermined condition is satisfied after the discriminator is generated by the discriminator generating means, and the discriminator generating means may generate the discriminator on the basis of the random feature amount of the learning image to which the pseudo positive image is added.

The positive image adding means may add the pseudo positive image as the learning image in a case where a condition in which the total number of the positive image and the pseudo positive image is smaller than the total number of the negative image and the pseudo negative image is satisfied.

The learning means may perform the learning using an SVM (support vector machine) as the margin maximization learning.

The learning apparatus may further include discriminating means for discriminating whether the predetermined discrimination target is present in a discrimination target image, and in a case where the learning image is newly designated according to a discrimination process of the discriminating means by the user, the learning means may repeatedly perform the learning of the discriminator using the designated learning image.

In a case where generation of an image cluster including the discrimination target images in which the predetermined discrimination target is present in the image is instructed according to the discrimination process of the discriminating means by the user, the discriminating means may generate the image cluster from the plurality of discrimination target images on the basis of the newest discriminator generated by the learning means.

According to an embodiment of the present invention, there is provided a learning method in a learning apparatus which learns a discriminator for discriminating whether a predetermined determination target is present in an image. Here, the learning apparatus includes learning means, and the method includes the step of: learning, according as a learning image used for learning the discriminator for discriminating whether the predetermined discrimination target is present in the image is designated from a plurality of sample images by a user, the discriminator using a random feature amount including a dimension feature amount randomly selected from among a plurality of dimension feature amounts included in an image feature amount indicating features of the learning image, by the learning means.

According to the embodiments of the present invention, according as a learning image used for learning a discriminator for discriminating whether a predetermined discrimination target is present in an image is designated from among a plurality of sample images by a user, the discriminator is learned using a random feature amount including a dimension feature amount randomly selected from a plurality of dimension feature amounts included in an image feature amount indicating features of the learning image.

According to the embodiments of the present invention, it is possible to suppress over-learning, to thereby learn a discriminator having high discrimination accuracy, in learning using a relatively small number of learning images.

### BRIEF DESCRIPTION OF THE DRAWINGS

FIG. 1 is a block diagram illustrating a configuration example of an image classification apparatus according to an embodiment of the present invention;

FIG. 2 is a diagram illustrating an outline of an image classification process performed by an image classification apparatus;

FIG. 3 is a diagram illustrating random indexing;

FIG. 4 is a diagram illustrating generation of a weak discriminator;

FIG. 5 is a diagram illustrating cross validation;

FIG. 6 is a flowchart illustrating an image classification process performed by an image classification apparatus;

FIG. 7 is a flowchart illustrating a learning process performed by a learning section;

FIG. 8 is a flowchart illustrating a discrimination process performed by a discriminating section;

FIG. 9 is a flowchart illustrating a feedback learning process performed by a learning section; and

FIG. 10 is a block diagram illustrating a configuration example of a computer.

### DESCRIPTION OF THE PREFERRED EMBODIMENTS

Hereinafter, preferred exemplary embodiments for carrying out the present invention will be described. The description will be made in the following order:

1. Embodiment (example in a case where a discriminator is generated using a random feature amount of a learning image)
2. Modified examples

### 1. Embodiment

[Configuration example of image classification apparatus 1]

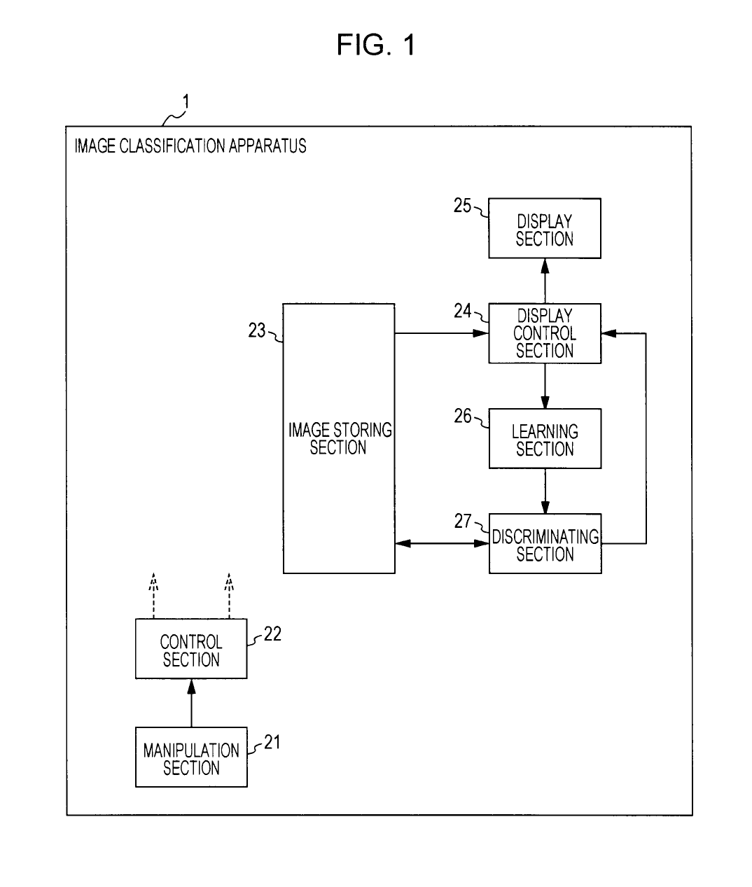

FIG. 1 is a diagram illustrating a configuration example of an image classification apparatus 1 according to an embodiment of the present invention.

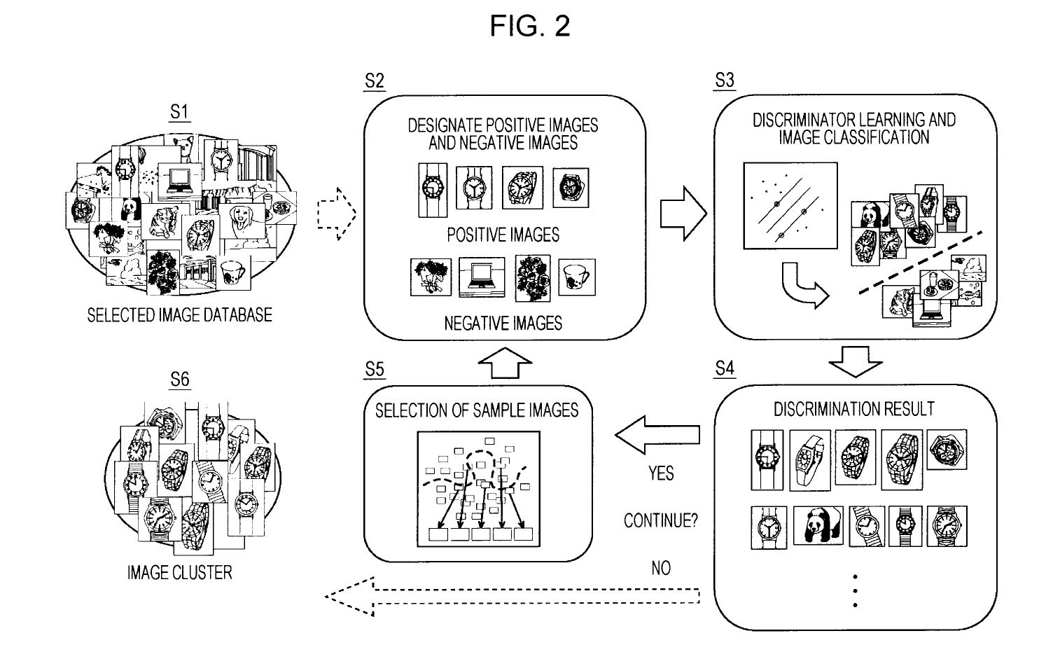

The image classification apparatus 1 discriminates whether a predetermined discrimination target (for example, a watch shown in FIG. 2, or the like) is present in each of a plurality of images stored (retained) in the image classification apparatus 1.

Further, the image classification apparatus 1 classifies the plurality of images into a class in which the predetermined discrimination target is present and a class in which the predetermined discrimination target is not present on the basis of the discrimination result, and generates and stores an image cluster including images classified into the class in which the predetermined discrimination target is present.

The image classification apparatus 1 includes a manipulation section 21, a control section 22, an image storing section 23, a display control section 24, a display section 25, a learning section 26, and an discriminating section 27.

For example, the manipulation section 21 includes a manipulation button or the like which is manipulated by a user and then supplies a manipulation signal according to the manipulation of the user to the control section 22.

The control section 22 controls the display control section 24, the learning section 26, the discriminating section 27, and the like according to the manipulation signal from the manipulation section 21.

The image storing section 23 includes a plurality of image databases which store images.

The display control section 24 reads out a plurality of sample images from a selected image database according to a selection manipulation of the user among the plurality of image databases for forming the image storing section 23 under the control of the control section 22, and then supplies the read-out sample images to the display section 25 to be displayed.

Here, the sample images are images displayed for allowing a user to designate a positive image indicating an image in which the predetermined discrimination target is present in the image (for example, an image in which a watch is present as a subject on the image), and a negative image indicating an image in which the predetermined discrimination target is not present in the image (for example, an image in which the watch is not present as the subject on the image).

The display control section 24 attaches, to a sample image designated according to a designation manipulation of the user among the plurality of sample images displayed on the display section 25, a correct solution label corresponding to the designation manipulation of the user. Further, the display control section 24 supplies the sample image to which the correct solution label is attached to the learning section 26 as a learning image.

Here, the correct solution label indicates whether the sample image is the positive image or negative image, and includes a positive label indicating that the sample image is the positive image and a negative label indicating that the sample image is the negative image.

That is, the display control section 24 attaches the positive label to the sample image which is designated as the positive image by the designation manipulation of the user, and attaches the negative label to the sample image which is designated as the negative image by the designation manipulation of the user. Further, the display control section 24 supplies the sample image to which the positive label or the negative label is attached to the learning section 26, as the learning image.

Further, the display control section 24 supplies the image in which it is discriminated that the predetermined discrimination target is present as the discrimination result from the discriminating section 27, to the display section 25 to be displayed.

The display section 25 displays the sample images from the display control section 24, the discrimination result or the like.

The learning section 26 performs a learning process for generating a discriminator for discriminating whether the predetermined discrimination target (for example, watch shown in FIG. 2) is present in the image on the basis of the learning image from the display control section 24, and supplies the discriminator obtained as a result to the discriminating section 27.

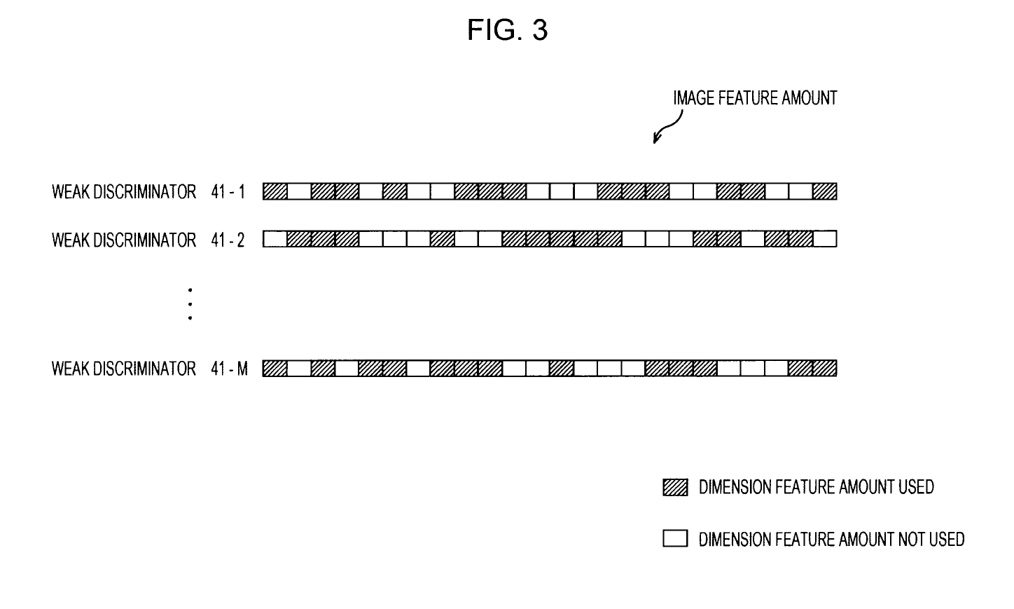

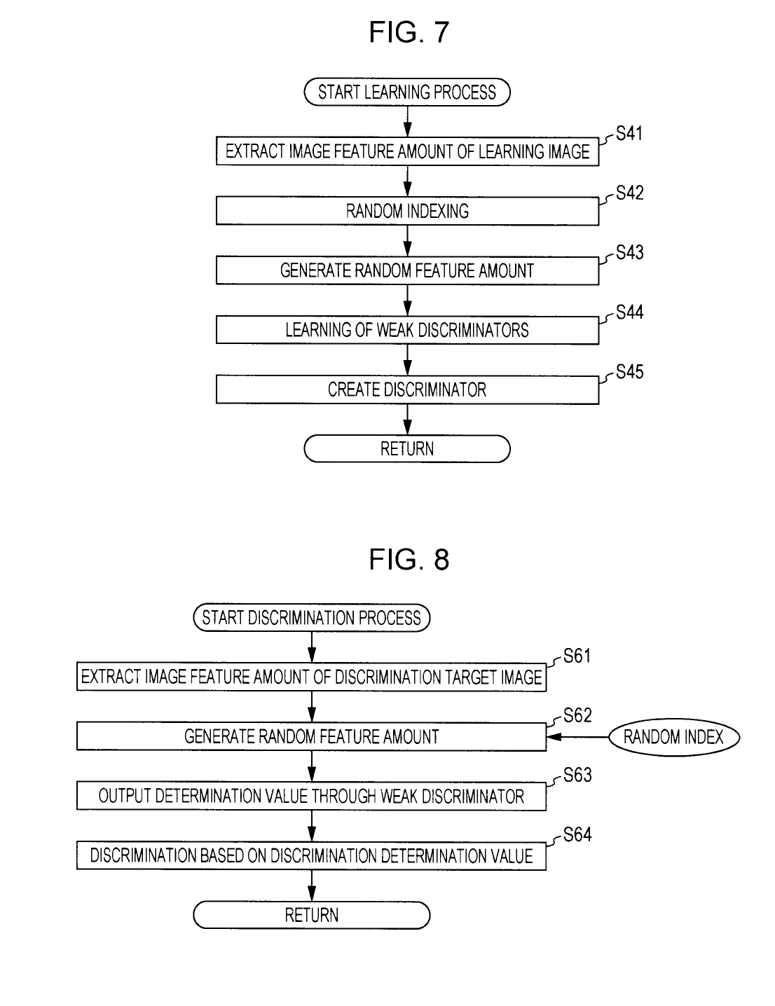

Details of the learning process performed by the learning section 26 will be described later with reference to FIGS. 3 to 5 and a flowchart in FIG. 7.

The discriminating section 27 performs a discrimination process for discriminating whether the predetermined discrimination target is present in the image (here, excluding the learning image) stored in the image database which is selected by the selection manipulation of the user, occupied by the image storing section 23, using the discriminator from the learning section 26.

Further, the discriminating section 27 supplies the image in which it is discriminated in the discrimination process that the predetermined discrimination target is present in the image, to the display control section 24 as the discrimination result. Details of the discrimination process performed by the discriminating section 27 will be described later with reference to a flowchart in FIG. 8.

### [Outline of Image Classification Process Performed by Image Classification Apparatus 1]

FIG. 2 illustrates an outline of the image classification process performed by the image classification apparatus 1.

In step S1, the display control section 24 reads out the plurality of sample images from the image database selected by the selection manipulation of the user (hereinafter, referred to as “selected image database”), among the plurality of image databases for forming the image storing section 23, and then supplies the read-out sample images to the display section 25 to be displayed.

In this case, the user performs the designation manipulation for designating positive images or negative images, from the plurality of sample images displayed on the display section 25 using the manipulation section 21. That is, for example, the user performs the designation manipulation for designating sample images in which the watch is present in the image as the positive images or sample images in which a subject other than the watch is present in the image as the negative images.

In step S2, the display control section 24 attaches a positive label to the sample images designated as the positive images. Contrarily, the display control section 24 attaches a negative label to the sample images designated as the negative images. Further, the display control section 24 supplies the sample images to which the positive label or the negative label is attached to the learning section 26 as learning images.

In step S3, the learning section 26 performs a learning process for generating a discriminator for discriminating whether the predetermined discrimination target (a watch in the example shown in FIG. 2) is present in the image, using the learning images from the display control section 24, and then supplies the discriminator obtained as a result to the discriminating section 27.

The discriminating section 27 reads out some of images (images to which the positive label or the negative label is not attached) other than the learning images among the plurality of images stored in the selected image databases of the image storing section 23 from the image storing section 23, as discrimination target images which are targets of the discrimination process.

Further, the discriminating section 27 performs the discrimination process for discriminating whether the predetermined discrimination target is present in the image, using the discriminator from the learning section 26, using the read-out of some discrimination target images as individual targets.

The discriminating section 27 supplies the discrimination target image in which it is discriminated in the discrimination process that the predetermined discrimination target is present in the image, to the display control section 24 as the discrimination result.

In step S4, the display control section 24 supplies the discrimination target image which is the discrimination result from the discriminating section 27 to the display section 25 to be displayed.

In a case where the user is not satisfied with classification accuracy of the images by means of the discriminator (for example, as shown in FIG. 2, in a case where an image including a panda as a subject is included in the discrimination result), with reference to the discrimination result displayed on the display section 25, the user performs an instruction manipulation for instructing generation of a new discriminator through the manipulation section 21. As the instruction manipulation is performed, the procedure goes to step S5 from step S4.

In step S5, the display control section 24 reads out a plurality of new sample images which is different from the plurality of sample images displayed in the process of the previous step S2 from the image database according to the instruction manipulation of the user, and then supplies the read-out new sample images to the display section 25 to be displayed. Then, the procedure returns to step S2, and then the same processes are performed.

Further, in a case where the user is satisfied with the classification accuracy of the images by means of the discriminator (for example, in a case where only the images including the watch as a subject are included in the discrimination result), with reference to the discrimination result displayed on the display section 25, the user performs an instruction manipulation for instructing generation of an image cluster by means of the discriminator, using the manipulation section 21.

According to the instruction manipulation, the procedure goes to step S6 from step S4. In step S6, the discriminating section 27 discriminates whether the predetermined discrimination target is present in the plurality of images stored in the selected image database, using the discriminator generated in the process of the previous step S3.

Further, the discriminating section 27 generates the image cluster formed by the images in which the predetermined discrimination target is present in the image on the basis of the discrimination result, and supplies it to the image storing section 23 to be stored. Then, the image classification process is terminated.

### [Learning Process Performed by Learning Section 26]

Next, the learning process performed by the learning section 26 will be described with reference to FIGS. 3 to 5.

The learning section 26 performs the learning process for generating the discriminator on the basis of the learning images from the display control section 24.

The discriminator includes a plurality of weak discriminators for discriminating whether the predetermined discrimination target is present in the image, and determines a final discrimination result on the basis of the discrimination results by means of the plurality of weak discriminators.

Accordingly, since the generation of the discriminator and the generation of the plurality of weak discriminators are equivalent in the learning process, the generation of the plurality of weak discriminators will be described hereinafter.

The learning section 26 extracts image feature amounts which indicate features of the learning images from the learning images supplied from the display control section 24 and are indicated as vectors of a plurality of dimensions.

Further, the learning section 26 generates the plurality of weak discriminators on the basis of the extracted image feature amounts. However, in a case where the generation of the discriminator is performed by a relatively small number of learning images, the dimensions of the image feature amounts of the learning images are high (the number of elements for forming a vector as an image feature amount is large), thereby causing over-learning (over-fitting).

Thus, in order to suppress over-learning, the learning section 26 performs random indexing for limiting the dimensions of the image feature amounts used for learning, according to the number of the learning images.

### [Random Indexing]

Next, FIG. 3 is a diagram illustrating the random indexing performed by the learning section 26.

FIG. 3 illustrates examples of random feature amounts used for generation of a plurality of weak discriminators 41-1 to 41-M.

In FIG. 3, as an image feature amount used for each of the plurality of weak discriminators 41-1 to 41-M, for example, an image feature amount indicated by a vector with 24 dimensions is shown.

Accordingly, in FIG. 3, the image feature amount is formed by 24 dimension feature amounts (elements).

The learning section 26 generates a random index indicating a dimension feature amount used for generation of each of the weak discriminators 41-1 to 41-M, among the plurality of dimension feature amounts forming the image feature amounts.

That is, for example, the learning section 26 randomly determines a predetermined number of dimension feature amounts used for learning of each of the weak discriminators 41-1 to 41-M, among the plurality of dimension feature amounts forming the image feature amount of the learning image, for each of the plurality of weak discriminators 41-1 to 41-M.

The number of the dimension feature amounts used for the learning of each of the weak discriminators 41-1 to 41-M is small such that over-learning does not occur, by the experiment result or the like performed in advance according to the number of learning images, the number of dimension feature amounts forming the image feature amounts of the learning images, or the like.

Further, the learning section 26 performs the random indexing for generating the random indexes indicating the randomly determined dimension feature amounts, that is, the random indexes indicating the order of the randomly determined dimension feature amounts in the elements forming the vector which is the image feature amount.

Specifically, for example, the learning section 26 generates random indexes indicating 13 dimension feature amounts which are present in first, third, fourth, sixth, ninth to eleventh, fifteenth to seventeenth, twentieth, twenty-first and twenty-fourth positions (indicated by oblique lines in FIG. 3) among twenty-four elements for forming the vector which are image feature amounts, as the dimension feature amounts used for learning of the weak discriminator 41-1.

Further, for example, the learning section 26 similarly generates the random indexes indicating the dimension feature amounts used for learning of the weak discriminators 41-2 to 41-M, respectively.

The learning section 26 extracts the dimension feature amounts indicated by the random indexing, among the plurality of dimension feature amounts forming the image feature amount of the learning image, on the basis of the random indexes generated for each of the weak discriminators 41-1 to 41-M to be generated.

Further, the learning section 26 generates the weak discriminators 41-1 to 41-M, on the basis of the random feature amounts formed by the extracted dimension feature amounts.

### [Generation of Weak Discriminators]

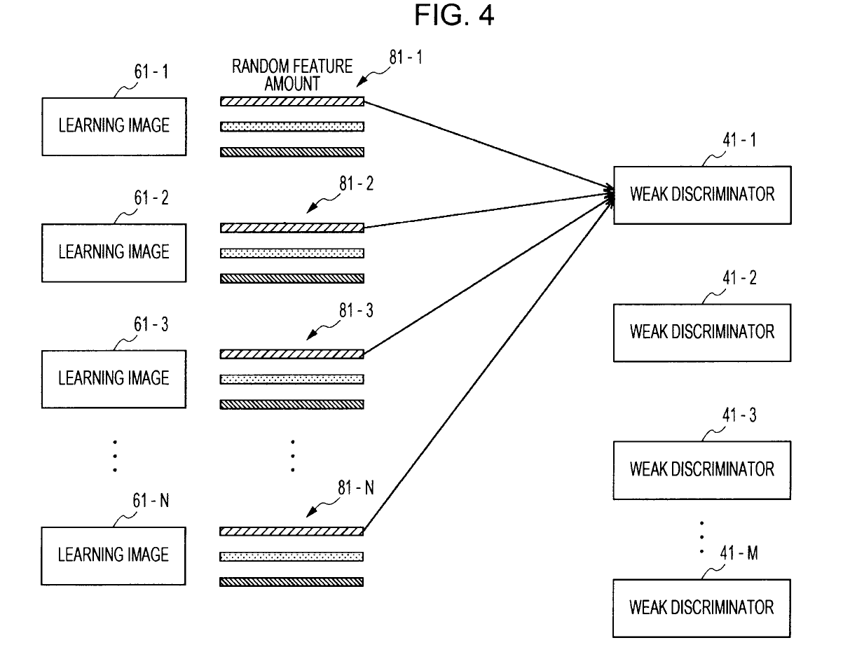

Next, FIG. 4 illustrates an example of generating the weak discriminators 41-1 to 41-M using the random feature amounts extracted on the basis of the random indexes by the learning section 26.

On the left side in FIG. 4, learning images 61-1 to 61-N which are supplied to the learning section 26 from the display control section 24 are shown.

The learning section 26 extracts random feature amounts 81-n which are formed by dimension feature amounts extracted by image feature amounts of learning images 61-n (n=1, 2, . . . N) from the display control section 24, on the basis of the random indexes generated for the weak discriminator 41-1.

Further, the learning section 26 performs the generation of the weak discriminator 41-1 using an SVM (support vector machine) on the basis of N random feature amounts 81-1 to 81-N which are extracted from the image feature amounts of the learning images 61-1 to 61-N, respectively.

Here, the SVM refers to a process for building a separating hyper-plane called a support vector (boundary surface for use in discrimination of images, and a boundary surface on a feature space in which dimension feature amounts forming the random feature amounts exist) so as to maximize a margin which is positioned near the separating hyper-plane and is a distance between the dimension feature amount positioned around the separating hyper-plane and the separating hyper-plane, among the dimension feature amounts forming each of the given random feature amounts 81-1 to 81-N, and then for generating the weak discriminator for performing discrimination of the images using the built separating hyper-plane.

The learning section 26 performs the generation of the weak discriminators 41-2 to 41-M in addition to the weak discriminator 41-1. Here, since the generation method is the same as in the weak discriminator 41-1, description thereof will be omitted. This is similarly applied to the following description.

Further, in a case where the SVM is applied in the generation of the weak discriminator 41-1 using the SVM, parameters appearing in a kernel function, parameters for a penalty control appearing by alleviation to a soft margin, or the like are used in the SVM.

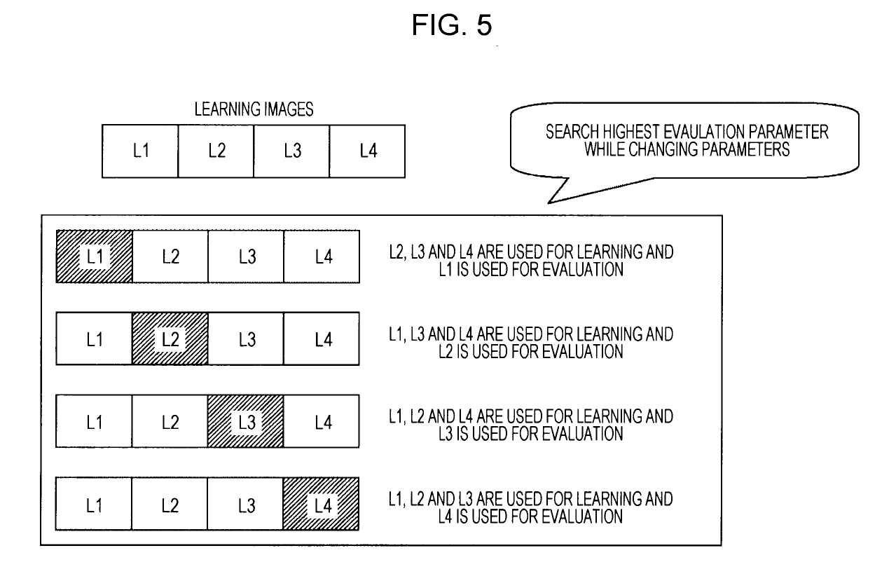

Accordingly, it is necessary for the learning section 26 to determine the parameters used for the SVM by a determination method as shown in FIG. 5, for example, before performing the generation of the weak discriminator 41-1 using the SVM.

### [Determination Method of Parameters Using Cross Validation]

Next, a determination method which is performed by the learning section 26 for determining the parameters used for the SVM using a cross validation will be described with reference to FIG. 5.

On an upper side in FIG. 5, for example, learning images L1 to L4 are shown as the learning images supplied to the learning section 26 from the display control section 24. Among the learning images L1 to L4, the learning images L1 and L2 represent the positive images, and the learning images L3 and L4 represent the negative images.

The learning section 26 performs the cross validation for sequentially setting a plurality of candidate parameters which are candidates of the parameters used in the SVM as attention parameters and for calculating evaluation values indicating evaluations for the attention parameters.

That is, for example, the learning section 26 sequentially sets the four learning images L1 to L4 as attention learning images (for example, learning image L1). Further, the learning section 26 generates the weak discriminator 41-1, by applying the SVM using the attention parameter to the remaining learning images (for example, learning images L2 to L4) which are different from the attention learning image, among the four learning images L1 to L4. Further, the learning section 26 discriminates whether the predetermined discrimination target is present in the image, using the attention learning image as a target, using the generated weak discriminator 41-1.

The learning section 26 discriminates whether the attention learning image is correctly discriminated by the weak discriminator 41-1, on the basis of the discrimination result of the weak discriminator 41-1 and the correct solution label attached to the attention learning image.

As shown in FIG. 5, the learning section 26 determines whether each of the four learning images L1 to L4 is correctly discriminated by sequentially using all the four learning images L1 to L4 as attention learning images. Further, for example, the learning section 26 generates a probability that each of the four learning images L1 to L4 is capable of being accurately discriminated, on the basis of the determination result as the evaluation value of the attention parameter.

The learning section 26 determines the candidate parameter corresponding to the maximum evaluation value (highest evaluation value), among the plurality of evaluation values calculated for the respective candidate parameters which are the attention parameters, as a final parameter used for the SVM.

Further, the learning section 26 performs the learning process for generating the weak discriminators 41-m (m=1, 2, . . . , M) by the SVM to which the determined parameter is applied, on the basis of the four learning images L1 to L4.

Further, the learning section 26 calculates a confidence indicating the degree of confidence of discrimination performed by the generated weak discriminators 41-m according to the following formula 1.

$$\begin{matrix}[ Formula 1 ] & \\ confidence = \frac{\# of true positive + \# of true negative}{\# of training data} & ( 1 )\end{matrix}$$

In the formula 1, “# of true positive” represents times in which it is correctly discriminated that the positive images which are the learning images in the weak discriminators 41-m are the positive images.

Further, in the formula 1, “# of true negative” represents times in which it is correctly discriminated that the negative images which are the learning images in the weak discriminators 41-m are the negative images. Further, “# of training data” represents the number of the learning images (positive images and negative images) used for generation of the weak discriminators 41-m.

Further, the learning section 26 generates the discriminator for outputting a discrimination determination value yI as shown in the following formula 2, on the basis of the generated weak discriminators 41-m and the confidence of the weak discriminators 41-m (hereinafter, referred to as “confidence aₘ”).

$$\begin{matrix}[ Formula 2 ] & \\ {y}^{I} = {\sum }_{m = 1}^{M} {a}_{m} {y}_{m} & ( 2 )\end{matrix}$$

In the formula 2, M represents the total number of the weak discriminators 41-m, and the discrimination determination value yI represents a calculation result due to a product-sum operation of the determination values yₘ output from the respective weak discriminators 41-m and the confidence aₘ of the weak discriminators 41-m.

Further, if it is discriminated that the discrimination target is present in the image on the basis of the input random feature amounts, the weak discriminators 41-m output positive values as the determination values yₘ, and if it is discriminated that the discrimination target is not present in the image, the weak discriminators 41-m output negative values as the determination values yₘ.

The determination values yₘ are defined by the distance between the random feature amounts and the separating hyper-plane input to the weak discriminators 41-m or a probability expression through a logistic function.

In a case where a discrimination target image I is input to the discriminator generated by the learning section 26, the discriminating section 27 discriminates that the predetermined discrimination target is present in the discrimination target image I, when the discrimination determination value yI output from the discriminator is a positive value. Further, when the discrimination determination value yI output from the discriminator is a negative value, the discriminating section 27 discriminates that the predetermined discrimination target is not present in the discrimination target image I.

### [Operation of Image Classification Apparatus 1]

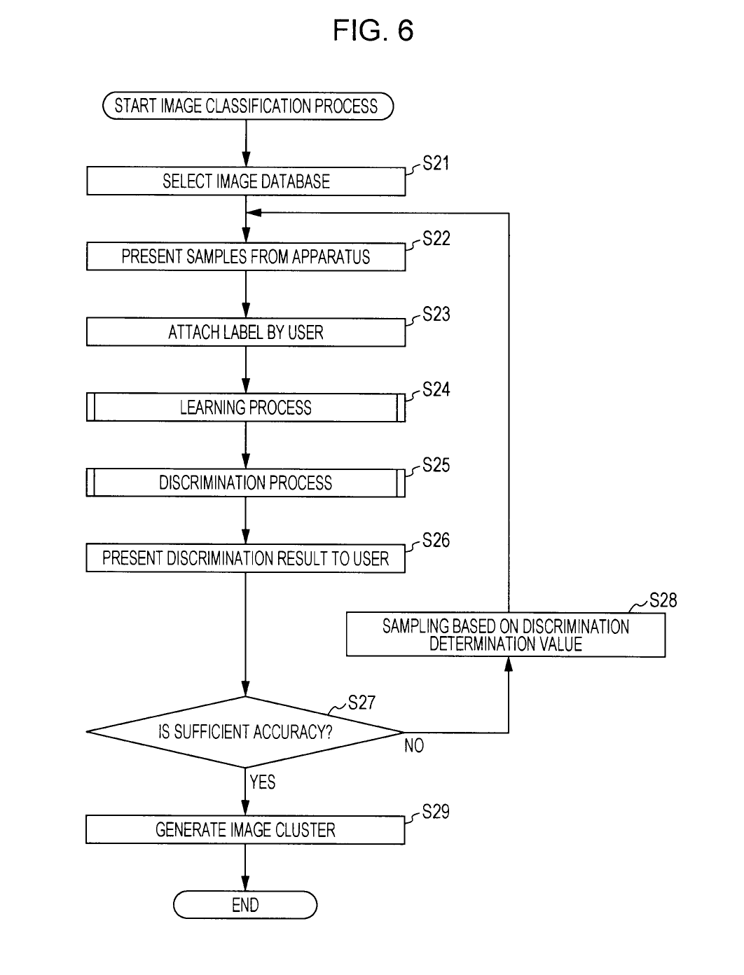

Next, an image classification process performed by the image classification apparatus 1 will be described with reference to a flowchart in FIG. 6.

For example, the image classification process is started when the user manipulates the manipulation section 21 so as to select an image database which is the target of the image classification process among the plurality of image databases for forming the image storing section 23. At this time, the manipulation section 21 supplies a manipulation signal corresponding to the selection manipulation of the image database from the user to the control section 22.

In step S21, the process corresponding to the step S1 in FIG. 2 is performed. That is, in step S21, the control section 22 selects the image database selected by the selection manipulation from the user among the plurality of image databases for forming the image storing section 23, as the selected image database which is the target of the image classification process, according to the manipulation signal from the manipulation section 21.

In steps S22 and S23, a process corresponding to the step S2 in FIG. 2 is performed.

That is, in step S22, the display control section 24 reads out the plurality of sample images from the selected image database of the image storing section 23 under the control of the control section 22 and then supplies the read-out sample images to the display section 25 to be displayed.

According to the number of the positive images and the negative images designated from the plurality of sample images displayed on the display section 25 through the manipulation section 21 by the user, the procedure goes to step S23 from step S22.

Further, in step S23, the display control section 24 attaches the positive label to the sample images designated as the positive images. Contrarily, the display control section 24 attaches the negative label to the sample images designated as the negative images. Further, the display control section 24 supplies the sample images to which the positive label or the negative label is attached to the learning section 26 as the learning images.

In steps S24 and S25, a process corresponding to step S3 in FIG. 2 is performed.

That is, in step S24, the learning section 26 performs the learning process on the basis of the learning images from the display control section 24, and supplies the discriminators and the random indexes obtained by the learning process to the discriminating section 27. Details of the learning process performed by the learning section 26 will be described later with reference to a flowchart in FIG. 7.

In step S25, the discriminating section 27 reads out, from the image storing section 23, some images other than the learning images among the plurality of images stored in the selected image database in the image storing section 23, as discrimination target images which are targets of the discrimination process.

Further, the discriminating section 27 performs the discrimination process for discriminating whether the predetermined discrimination target is present in the image, using the discriminators and the random indexes from the learning section 26, using the several read-out discrimination target images as individual targets. Details of the discrimination process performed by the discriminating section 27 will be described later with reference to a flowchart in FIG. 8.

Further, the discriminating section 27 supplies the discrimination target image in which it is discriminated in the discrimination process that the predetermined discrimination target is present in the image, to the display control section 24 as the discrimination result.

In steps S26 and S27, a process corresponding to step S4 in FIG. 2 is performed.

That is, in step S26, the display control section 24 supplies the discrimination result from the discriminating section 27 to the display section 25 to be displayed.

In a case where the user is not satisfied with the accuracy of image classification by means of the discriminators generated in the process of the previous step S24, with reference to the discrimination result displayed on the display section 25, the user performs an instruction manipulation for instructing generation of a new discriminator using the manipulation section 21.

Further, in a case where the user is satisfied with the accuracy of image classification by means of the discriminators generated in the process of the previous step S24, with reference to the discrimination result displayed on the display section 25, the user performs an instruction manipulation for instructing generation of an image cluster using the discriminators using the manipulation section 21.

The manipulation section 21 supplies a manipulation signal according to the instruction manipulation of the user to the control section 22.

In step S27, the control section 22 determines whether the user is satisfied with the accuracy of image classification by means of the discriminators on the basis of the manipulation signal corresponding to the instruction manipulation of the user, from the manipulation section 21. If it is determined that the user is not satisfied with the accuracy of image classification, the procedure goes to step S28.

In step S28, a process corresponding to step S5 in FIG. 2 is performed.

That is, in step S28, the display control section 24 newly reads out a plurality of sample images from the selected image database of the image storing section 23, on the basis of the discrimination determination value yI in the plurality of images stored in the selected image database of the image storing section 23, under the control of the control section 22.

Specifically, for example, the display control section 24 determines images in which the discrimination determination value yI by means of the discriminators generated in the process of the previous step S24 among the plurality of images stored in the selected image database of the image storing section 23 satisfies a certain condition (for example, a condition that an absolute value of the discrimination determination value yI is smaller than a predetermined threshold), as the sample images, respectively.

Further, the display control section 24 reads out the plurality of sample images determined from the selected image database of the image storing section 23.

Then, the display control section 24 returns the procedure to step S22. In step S22, the plurality of sample images read out in the process of the previous step S28 is supplied to the display section 25 to be displayed, and the procedure goes to step S23. Then, the same processes are performed.

Further, in step S27, the control section 22 allows the procedure to go to step S29, if it is determined that the user is satisfied with the accuracy of image classification by means of the discriminators, on the basis of the manipulation signal corresponding to the instruction manipulation of the user from the manipulation section 21.

In step S29, a process corresponding to step S6 in FIG. 2 is performed. That is, in step S29, the discriminating section 27 generates the image cluster formed by the images in which the predetermined discrimination target is present, among the plurality of images stored in the selected image database of the image storing section 23, on the basis of the discriminators generated in the process of the previous step S24, and then supplies it to the image storing section 23 to be stored. Here, the image classification process is terminated.

### [Details of Learning Process Performed by Learning Section 26]

Next, details of the learning process in step S24 in FIG. 6, performed by the learning section 26 will be described with reference to a flowchart in FIG. 7.

In step S41, the learning section 26 extracts an image feature amount which indicates features of the learning image from each of the plurality of learning images supplied from the display control section 24 and is expressed as a vector with a plurality of dimensions.

In step S42, the learning section 26 performs the random indexing for generating the random indexes for the respective weak discriminators 41-m to be generated. Here, if the generated random indexes are updated to different ones whenever the discriminator is newly generated in the learning process, the learning section 26 can prevent fixing of a solution space.

That is, the learning section 26 can prevent the learning from being performed in a feature space in which a fixed dimension feature amount is present, that is, in a fixed solution space, in the learning process which is performed several times according to the manipulation of the user, if the random indexes are updated to different ones whenever the discriminator is newly generated.

In step S43, the learning section 26 generates the random feature amount used for generation of the weak discriminator 41-m, from each of the plurality of learning images, on the basis of the random indexes generated for the weak discriminators 41-m.

That is, for example, the learning section 26 selects the dimension feature amounts indicated by the random indexes generated for the weak discriminator 41-m, among the plurality of dimension feature amounts forming the image feature amount extracted from each of the plurality of learning images, and then generates the random feature amount formed by the selected dimension feature amounts.

In step S44, the learning section 26 generates the weak discriminators 41-m by applying the SVM to the random feature amount generated for each of the plurality of learning images. Further, the learning section 26 calculates the confidence aₘ of the weak discriminators 41-m.

In step S45, the learning section 26 generates the discriminator for outputting the discrimination determination value yI shown in the formula 2, on the basis of the generated weak discriminators 41-m and the confidence aₘ of the weak discriminators 41-m, and then the procedure returns to step S24 in FIG. 6.

Further, in step S24 in FIG. 6, the learning section 26 supplies the random indexes for each of the weak discriminators 41-1 to 41-M generated in the process of step S42 and the discriminator generated in the process of step S45 to the discriminating section 27, and then the procedure goes to step S25.

### [Details of Discrimination Process Performed by Discriminating Section 27]

Next, details of the discrimination process in step S25 in FIG. 6 performed by the discriminating section 27 will be described with reference to a flowchart in FIG. 8.

In step S61, the discriminating section 27 reads out some images other than the learning images from the selected image database of the image storing section 23, as discrimination target images I, respectively.

Further, the discriminating section 27 extracts an image feature amount indicating features of the discrimination target image, from the read-out discrimination target image I.

In step S62, the discriminating section 27 selects the dimension feature amounts indicated by the random indexes corresponding to the weak discriminators 41-m from the learning section 26, from among the plurality of dimension feature amounts forming the extracted image feature amount, and then generates the random feature amounts formed by the selected dimension feature amounts.

The random indexes of each of the weak discriminators 41-m generated in the process of step S42 in the learning process immediately before the discrimination process is performed are supplied to the discriminating section 27 from the learning section 26.

In step S63, the discriminating section 27 inputs the random feature amount of the generated discrimination target image I to the weak discriminators 41-m occupied by the discriminator from the learning section 26. Thus, the weak discriminator 41-m outputs the determination values yₘ of the discrimination target image I, on the basis of the random feature amount of the discrimination target image I input from the discriminating section 27.

In step S64, the discriminating section 27 performs the product-sum operation shown in the formula 2, by inputting (assigning) the determination values yₘ output from the weak discriminators 41-m to the discriminator from the learning section 26, that is, to the formula 2, and then calculates the discrimination determination value yI of the discrimination target image I.

Further, the discriminating section 27 discriminates whether the discrimination target image I is a positive image or a negative image on the basis of the calculated discrimination determination value yI. That is, for example, in a case where the calculated discrimination determination value yI is a positive value, the discriminating section 27 discriminates that the discrimination target image I is a positive image, and in a case where the calculated discrimination determination value yI is not a positive value, the discriminating section 27 discriminates that the discrimination target image I is a negative image. Then, the discriminating section 27 terminates the discrimination process, and then the procedure returns to step S25 in FIG. 6.

As described above, in the image classification process, in the learning process of step S24, since the random feature amount lower in dimension than the image feature amount other than the image feature amount of the learning images is used, even in a case where the discriminator is generated on the basis of a small number of learning images, over-learning can be suppressed.

Further, in the learning process, the plurality of weak discriminators 41-1 to 41-M is generated using the SVM for improving the generalization performance of the discriminator by maximizing the margin from the random feature amount of the learning image.

Accordingly, in the learning process, since the discriminator having a high generalization performance can be generated while suppressing over-learning, it is possible to generate a discriminator with a relatively high discrimination accuracy, even in a small number of learning images.

Thus, in the image classification process, using the discriminator generated on the basis of a small number of learning images designated by the user, since it is possible to classify the images formed as the image cluster from different images with a relatively high accuracy, it is possible to generate the image cluster desired by the user with a high accuracy.

In the related art, there exists a discrimination method through random forests for discriminating images using the dimension feature amounts selected randomly.

In the discrimination method through the random forests, some learning images are randomly selected from the plurality of learning images, and then a bootstrap set formed by the selected learning images is generated.

Further, the learning images used for learning are selected from some learning images for forming the bootstrap set to perform the learning of the discriminator. The discrimination method through the random forests is disclosed in detail in [Leo Breiman, “Random Forests”, Machine Learning, 45, 5-32, 2001].

In this respect, in the present invention, the learning of the discriminator is performed using all the plurality of learning images designated by the user. Thus, in the present invention, since the learning of the discriminator is performed using more learning images compared with the discrimination method through the random forests, it is possible to generate the discriminator having a relatively high discrimination accuracy.

Further, in the discrimination method through the random forests, a determination tree is generated on the basis of dimension feature amounts, and then the learning of the discriminator is performed on the basis of the generated determination tree.

However, the learning based on the determination tree, performed in the discrimination method through the random forests, does not necessarily generate a discriminator which performs classification of the images using the separating hyper-plane built to maximize the margin.

In this respect, in the present invention, since the discriminator (weak discriminators) for image classification is generated using the separating hyper-plane built to maximize the margin through the SVM for maximizing the margin, it is possible to generate the discriminator having a high generalization performance by suppressing over-learning, even learning based on a small number of learning images.

In this way, in the embodiment of the present invention, it is possible to generate the discriminator having higher discrimination accuracy, compared with the discrimination method through the random forests in the related art.

### 2. Modified Examples

In the above-described embodiment, in order to suppress over-learning generated due to a small number of learning images, the random feature amount having a dimension lower than the image feature amount from the image feature amount of the learning image is generated and the discriminator is generated on the basis of the generated random feature amount, but the present invention is not limited thereto.

That is, as a cause of over-learning, a small number of learning images and a small number of positive images among the learning images are exemplified. Thus, for example, in the present embodiment, the number of positive images is increased by padding the positive images in a pseudo manner, to thereby suppress over-learning.

Here, in the related art, a pseudo relevance feedback process is provided for increasing a pseudo learning image on the basis of the learning image designated by the user.

In the pseudo relevance feedback process, the discriminator is generated on the basis of learning images designated by the user. Further, an image in which a discrimination determination value is equal to or higher than a predetermined threshold by discrimination of the generated discriminator, among a plurality of images which are not learning images (images to which a correct solution label is not attached) is selected as a pseudo positive image.

In the pseudo relevance feedback process, while a positive image is padded in the learning images in a pseudo manner, it is likely that a false-positive occurs in which a negative image in which a predetermined discrimination target is not present in the image is selected as the pseudo positive image.

Particularly, in the initial stages, in the discriminator generated on the basis of a small number of learning images, since discrimination accuracy due to a discriminator itself is low, the possibility that the false-positive occurs is relatively high.

Accordingly, in the learning section 26, in order to suppress the false-positive, it is possible to perform a feedback learning process for generating the discriminator by employing a background image as a pseudo negative image and for padding the pseudo positive image on the basis of the generated discriminator, instead of the learning process.

The background image refers to an image which is not classified into any class, in a case where the images stored in each of the plurality of image databases for forming the image storing section 23 are classified into classes based on the subject.

Accordingly, as the background image, for example, an image which does not include any subject which is present in the images stored in each of the plurality of image databases for forming the image storing section 23, specifically, for example, an image in which only the landscape as the subject is present in the image, or the like is employed. Further, the background image is stored in the image storing section 23.

### [Description of Feedback Learning Process]

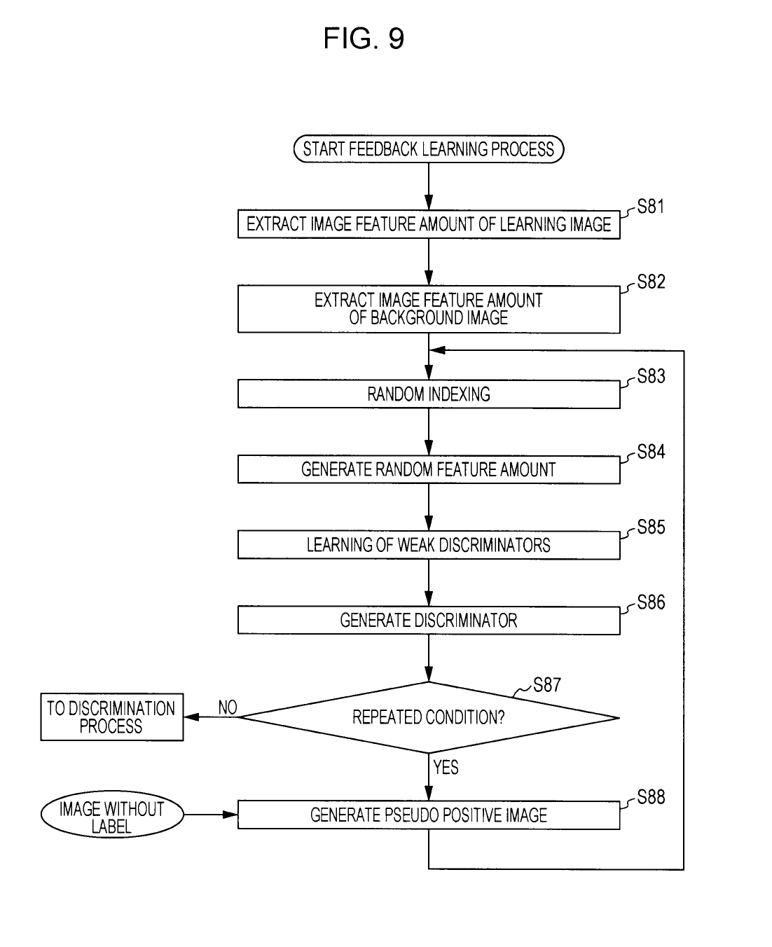

Next, FIG. 9 is a diagram illustrating details of the feedback learning process performed by the learning section 26, instead of the learning process in step S24 in FIG. 6.

In step S81, the same process as in step S41 in FIG. 7 is performed.

In step S82, the learning section 26 uses the background image stored in the image storing section 23 as a background negative image indicating the pseudo negative image. Further, the learning section 26 extracts the image feature amount indicating features of the background negative image from the background negative image.

In the process of step S82, the image feature amount of the background negative image extracted by the learning section 26 is used for generating a random feature amount of the background negative image in step S84.

The learning section 26 performs the same process as steps S42 and S45 in FIG. 7, respectively, using the respective positive image, negative image and background negative image as learning images, in steps S83 and S86.

In step S87, for example, the learning section 26 determines whether a repeated condition shown in the following formula 3 is satisfied.

[Formula 3]

if(Sₚ+Pₚ)<(S_{N}+B_{N}):true

else:false (3)

In the formula 3, Sₚ represents the number of positive images, Pₚ represents the number of pseudo positive images, S_{N} represents the number of negative images, and B_{N} represents the number of background negative image. Further, in the formula 3, it is assumed that Sₚ<(S_{N}+B_{N}) is satisfied.

In step S87, if the learning section 26 determines that the formula 3 is satisfied, the procedure goes to step S88.

In step S88, the learning section 26 reads out an image (an image which is not the learning image) to which the correct solution label is not attached as the discrimination target image I, from the selected image database of the image storing section 23. Further, the learning section 26 calculates the discrimination determination value yI of the read out discrimination target image I, using the discriminator after generation in the process of the previous step S86.

The learning section 26 attaches the positive label to the discrimination target image I corresponding to the discrimination determination value which is ranked highly, within the calculated discrimination determination value yI, and obtains the discriminating target image I to which the positive label is attached as the pseudo positive image.

In step S82, since the negative background image is padded as the pseudo negative image, the discrimination determination value yI which is calculated in the learning section 26 undergoes a downswing as a whole.

However, in this case, compared with the case where the pseudo negative image is not padded, the probability that the image ranked highly in the discrimination determination value yI is a positive image is further improved, and thus, it is possible to suppress the occurrence of the false-positive.

The learning section 26 newly adds the pseudo positive image obtained in the process of step S88 as the learning image, and then the procedure returns to step S83.

Further, in step S83, the learning section 26 generates random indexes which are different from the random indexes generated in the process of the previous step S83.

That is, the learning section 26 updates the random indexes into different ones whenever newly generating a discriminator, to thereby prevent the fixing of the solution space.

After the learning section 26 generates the random indexes, the procedure goes to step S84. Then, the learning section 26 generates the random feature amount on the basis of the random indexes generated in the process of the previous step S83, and performs the same processes thereafter.

In step S87, if the learning section 26 determines that the formula 3 is not satisfied, that is, if the learning section 26 determines that the discriminator is generated in the state where the pseudo positive images are sufficiently padded, the learning section 26 supplies the random indexes generated in the process of the previous step S83 and the discriminator generated in the process of the previous step S86 to the discriminating section 27.

Further, the learning section 26 terminates the feedback learning process, and then the procedure returns to step S24 in FIG. 6. Then, the discriminating section 27 performs a recognition process in step S25.

As described above, in the feedback learning process, the learning section 26 updates the random indexes in step S83, whenever the learning section 26 newly performs the processes of steps S83 to S86.

Accordingly, whenever the learning section 26 newly performs the processes of steps S83 to S86, the learning based on the SVM is performed in the feature space in which different dimension feature amounts exist, which is selected by the different random indexes, respectively.

For this reason, in the feedback learning process, for example, differently from the case where the discriminator is generated using fixed random indexes, it is possible to prevent the learning from being performed in the feature space in which the fixed dimension feature amounts exist, that is, in the fixed solution space.

Further, in the feedback learning process, before the discriminator is generated in step S86, in step S82, the negative image is padded using the background image as the negative background image indicating the pseudo negative image.

Thus, in the feedback learning process, since the discriminator in which the negative image is ranked in a high place can be restricted from being generated in step S86, in a case where the pseudo positive image is generated in step S88, it is possible to suppress the occurrence of the false-positive in which the negative image is mistakenly generated as the pseudo positive image.

Further, in the feedback learning process, even though a false-positive occurs, since the discriminator is generated using the SVM which maximizes the margin to enhance the generalization performance in step S86, it is possible to generate the discriminator having relatively high accuracy.

Accordingly, in the feedback learning process, compared with the pseudo relevance feedback process in the related art, it is possible to generate a desired image cluster of a user with higher accuracy.

In the feedback learning process, the processes of steps S83 to S86 are normally performed several times. This is because in a case where the processes of steps S83 to S86 are firstly performed, since the padding of the pseudo positive image through the process of step S88 is not performed yet, it is determined that the condition formula 3 is satisfied in the process of step S87.

In the feedback learning process, as the processes of step S83 to S86 are repeatedly performed, the pseudo positive image which is a learning image is padded. However, as repetition times of the processes of step S83 to S86 are increased, the calculation amount due to the processes is also increased.

Thus, the calculation amount for generating the discriminator can be reduced using the learning process and the feedback learning process together.

That is, for example, in the image classification process, in a case where the process of step S24 is firstly performed, the learning process of FIG. 7 is performed. In this case, in the first process (learning process) of step S24, the image in which the discrimination determination value yI is ranked highly is retained as the pseudo positive image, by the discrimination of the discriminator obtained by the learning process.

Further, in the image classification process, in the process of step S27, in a case where the procedure returns to step S22 through step S28, the processes of step S24 which is the second time or after are performed. At this time, as the process of step S24, the feedback learning process is performed.

In this case, in a state where the pseudo positive image which is retained in the first process of step S24 is padded as the learning image, the feedback learning process is performed.

Thus, in a case where the learning process and the feedback learning process are used together, the feedback learning process as the process of step S24 which is the second time or after is started in a state where the pseudo positive image is added in advance.

For this reason, in the feedback learning process as the process of step S24 which is the second time or after, since the total number (Sₚ+Pₚ) of positive images and the pseudo positive images is started in many states, compared with a case where only the feedback learning process is performed in step S24 of the image classification process, it is possible to reduce the number of processes of steps S83 to S86, and to reduce the calculation amount due to the process of step S24 of the image classification process.

Here, in a case where the learning process and the feedback learning process are used together, as more highly ranked images are used as the pseudo positive images on the basis of the discrimination result discriminated in the learning process, the condition formula 3 is more easily satisfied in step S87. Thus, it is possible to further reduce the calculation amount due to the process of step S24 of the image classification process.

However, since it is considered that the discriminator generated by the learning process as the first process of the step S24 has relatively low discrimination accuracy, the possibility that the above-described false-positive occurs is increased. However, since the discriminator which uses the SVM is generated in step S86, even though a false-positive occurs, it is possible to generate the discriminator having relatively high discrimination accuracy.

In the above-described image classification process, in step S25, the discriminating section 27 performs the discrimination process using some images other than the learning images among the plurality of images stored in the selected image database of the image storing section 23 as the target. However, for example, the discrimination process may be performed using all images other than the learning images among the plurality of images as the target.

In this case, in step S26, since the display control section 24 displays the discrimination results of all the images other than the learning images, among the plurality of images on the display section 25, the user can determine accuracy of the image classification by means of the discriminator generated in the process of the previous step S24 with higher accuracy.

Further, in step S25, the discriminating section 27 may perform the discrimination process using all the plurality of images (including the learning images) stored in the selected image database of the image storing section 23 as the target.

In this case, in a case where the procedure goes to step S29 through the steps S26 and S27 from step S25, in step S29, it is possible to easily generate the image cluster using the discrimination result in step S25.

Further, in the image classification process, in step S22, the display control section 24 displays the plurality of sample images on the display section 25, and correspondingly, the user designates the positive images and negative images from the plurality of sample images. However, for example, the user may designate only positive images.

That is, for example, only positive images are designated by the user, and in step S23, the display control section 24 may attach the positive label to the sample images designated as the positive images, and may attach the negative label using the background images as the negative images.

In this case, since the user has only to designate the positive images, it is possible to reduce user inconvenience for designating the positive images or negative images.

Further, in the present embodiment, the image classification apparatus 1 performs the image classification process using the plurality of images stored in the image database in the image storing section 23 included by the image classification apparatus 1 as the target. However, for example, the image classification process may be performed using a plurality of images stored in a storing device connected to the image classification apparatus 1 as the target.

Further, the image classification apparatus 1 may be any apparatus as long as it can classify the plurality of images into classes using the discriminator and can generate an image cluster for each classified class. For example, the image classification apparatus 1 may employ a personal computer or the like.

However, the above-described series of processes may be performed by exclusive hardware or software. In a case where the series of processes is performed by software, a program for forming the software is installed from a recording medium to a so-called embedded computer or, for example, to a versatile personal computer or the like which is capable of performing a variety of functions through installation of various programs.

### [Configuration Example of a Computer]

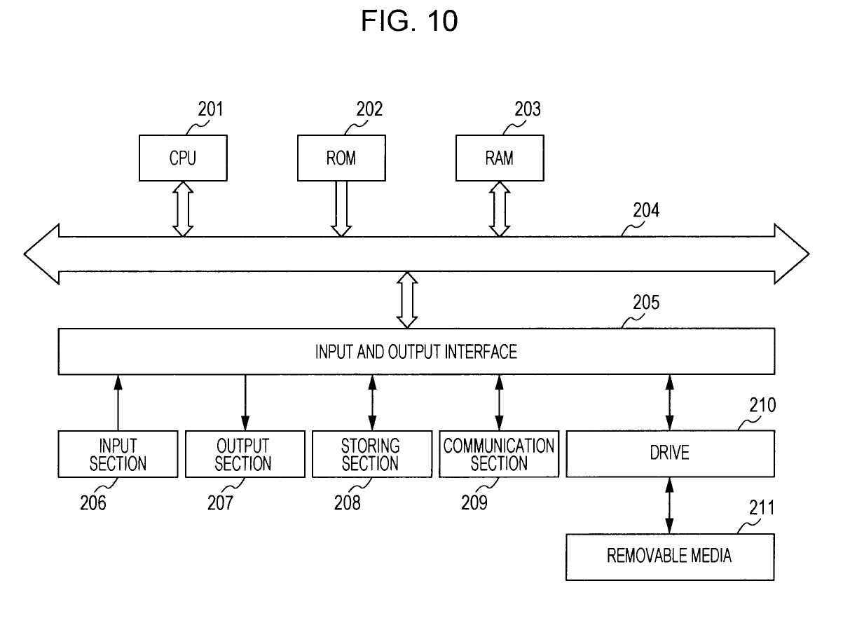

Next, FIG. 10 illustrates a configuration example of a computer for performing the above-described series of processes by a program.

A CPU (central processing unit) 201 performs a variety of processes according to a program stored in a ROM (read only memory) 202 or the storing section 208. Programs, data or the like executed by the CPU 201 are appropriately stored in a RAM (random access memory) 203. The CPU 201, the ROM 202 and the RAM 203 are connected with each other by a bus 204.

Further, an input and output interface 205 is connected with the CPU 201 through the bus 204. An input section 206 including a keyboard, a mouse, a microphone or the like, and an output section 207 including a display, a speaker or the like are connected with the input and output interface 205. The CPU 201 performs a variety of processes according to commands input from the input section 206. Further, the CPU 201 outputs the process result to the output section 207.

For example, a storing section 208 connected with the input and output interface 205 includes a hard disc, and stores the programs executed by the CPU 201 or various data. A communication section 209 communicates with an external apparatus through a network such as the internet or a local area network.

Further, the programs may be obtained through the communication section 209, and stored in the storing section 208.

When a removable media 211 such as a magnetic disc, optical disc, magnetic optical disc, semiconductor memory or the like is mounted, a drive 210 connected with the input and output interface 205 drives the removable media 211, and obtains programs, data or the like stored therein. The obtained programs or data are transmitted to the storing section 208 to be stored as necessary.

As shown in FIG. 10, recording mediums for recording (storing) programs which are installed in a computer and can be executed by the computer includes the removable media 211 which is a package media including an magnetic disc (including a flexible disc), optical disc (including a CD-ROM (compact disc-read only memory) and DVD (digital versatile disc)), optical magnetic disc (including MD (mini-disc)), semiconductor memory or the like; the ROM 202 in which programs are temporarily or permanently stored; the hard disc for forming the storing section 208, and the like. Recording of programs to the recording medium is performed using a wired or wireless communication medium such as a local area network, the internet, digital satellite, through the communication section 209 which is an interface such as a router, modem or the like as necessary.

In this description, the steps of the above-described series of processes may include a process of being temporally performed in the disclosed order, or a process of being performed in parallel or individually instead of the temporal process.

The present application contains subject matter related to that disclosed in Japanese Priority Patent Application JP 2010-011356 filed in the Japan Patent Office on Jan. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A learning apparatus comprising learning means for learning, according as a learning image used for learning a discriminator for discriminating whether a predetermined discrimination target is present in an image is designated from a plurality of sample images by a user, the discriminator using a random feature amount including a dimension feature amount randomly selected from a plurality of dimension feature amounts included in an image feature amount indicating features of the learning image.

2. The learning apparatus according to claim 1,
wherein the learning means learns the discriminator through margin maximization learning for maximizing a margin indicating a distance between a separating hyper-plane for discriminating whether the predetermined discrimination target is present in the image and a dimension feature amount existing in proximity to the separating hyper-plane among dimension feature amounts included in the random feature amount, in a feature space in which the random feature amount is present.

3. The learning apparatus according to claim 2,
wherein the learning means includes:
image feature amount extracting means for extracting the image feature amount which indicates the features of the learning image and is expressed as a vector with a plurality of dimensions, from the learning image;
random feature amount generating means for randomly selecting some of the plurality of dimension feature amounts which are elements of respective dimensions of the image feature amount and for generating the random feature amount including the selected dimension feature amounts; and
discriminator generating means for generating the discriminator through the margin maximization learning using the random feature amount.

4. The learning apparatus according to claim 3,
wherein the discriminator outputs a final determination result on the basis of a determination result of a plurality of weak discriminators for determining whether the predetermined discrimination target is present in a discrimination target image,
wherein the random feature amount generating means generates the random feature amount used to generate the weak discriminators for each of the plurality of weak discriminators, and
wherein the discriminator generating means generates the plurality of weak discriminators on the basis of the random feature amount generated for each of the plurality of weak discriminators.

5. The learning apparatus according to claim 4,
wherein the discriminator generating means further generates confidence indicating the level of reliability of the determination of the weak discriminators, on the basis of the random feature amount.

6. The learning apparatus according to claim 5,
wherein the discriminator generating means generates the discriminator which outputs a discrimination determination value indicating a product-sum operation result between a determination value which is a determination result output from each of the plurality of weak discriminators and the confidence, on the basis of the plurality of weak discriminators and the confidence, and
wherein the discriminating means discriminates whether the predetermined discrimination target is present in the discrimination target image, on the basis of the discrimination determination value output from the discriminator.

7. The learning apparatus according to claim 3,
wherein the random feature amount generating means generates a different random feature amount whenever the learning image is designated by the user.

8. The learning apparatus according to claim 7,
wherein the learning image includes a positive image in which the predetermined discrimination target is present in the image and a negative image in which the predetermined discrimination target is not present in the image, and
wherein the learning means further includes negative image adding means for adding a pseudo negative image as the learning image.

9. The learning apparatus according to claim 8,
wherein the learning means further includes positive image adding means for adding a pseudo positive image as the learning image in a case where a predetermined condition is satisfied after the discriminator is generated by the discriminator generating means, and
wherein the discriminator generating means generates the discriminator on the basis of the random feature amount of the learning image to which the pseudo positive image is added.

10. The learning apparatus according to claim 9,
wherein the positive image adding means adds the pseudo positive image as the learning image in a case where a condition in which the total number of the positive image and the pseudo positive image is smaller than the total number of the negative image and the pseudo negative image is satisfied.

11. The learning apparatus according to claim 2,
wherein the learning means performs the learning using an SVM (support vector machine) as the margin maximization learning.

12. The learning apparatus according to claim 1,
further comprising discriminating means for discriminating whether the predetermined discrimination target is present in a discrimination target image using the discriminator,
wherein in a case where the learning image is newly designated according to a discrimination process of the discriminating means by the user, the learning means repeatedly performs the learning of the discriminator using the designated learning image.

13. The learning apparatus according to claim 12,
wherein in a case where generation of an image cluster including the discrimination target images in which the predetermined discrimination target is present in the image is instructed according to the discrimination process of the discriminating means by the user, the discriminating means generates the image cluster from the plurality of discrimination target images on the basis of the newest discriminator generated by the learning means.

14. A learning method in a learning apparatus which learns a discriminator for discriminating whether a predetermined discrimination target is present in an image,
the learning apparatus including learning means,
the method comprising the step of: learning, according as a learning image used for learning the discriminator for discriminating whether the predetermined discrimination target is present in the image is designated from among a plurality of sample images by a user, the discriminator using a random feature amount including a dimension feature amount randomly selected from a plurality of dimension feature amounts included in an image feature amount indicating features of the learning image, by the learning means.

15. A program which causes a computer to function as learning means for learning, according as a learning image used for learning a discriminator for discriminating whether a predetermined discrimination target is present in an image is designated from a plurality of sample images by a user, the discriminator using a random feature amount including a dimension feature amount randomly selected from among a plurality of dimension feature amounts included in an image feature amount indicating features of the learning image.

16. A learning apparatus comprising a learning section which learns, according as a learning image used for learning a discriminator for discriminating whether a predetermined discrimination target is present in an image is designated from a plurality of sample images by a user, the discriminator using a random feature amount including a dimension feature amount randomly selected from a plurality of dimension feature amounts included in an image feature amount indicating features of the learning image.
